(19) United States
(12) Patent Application Publication
(10) Pub. No.: US 2015/0242958 A1
(43) Pub. Date: Aug. 27, 2015

(54) Counter-party license transaction (C.P.L.T.)

(71) Applicant: David Andrew D'Zmura, Borrego Springs, CA (US)

(72) Inventor: David Andrew D'Zmura, Borrego Springs, CA (US)

(21) Appl. No.: 12/928,357

(22) Filed: Dec. 8, 2010

(51) Int. Cl. G06Q 40/00

(52) U.S. Cl. CPC G06Q 40/10

(57) ABSTRACT

A Business Method Invention, to transact an Independent Inventor's Intangible Assets into Industry of Inventor's native Nation. A Process means to convey license usage to top-most Governmental and Industry leadership agencies and corporations, providing the formation, booking, or floating of Treasury Assets, a cash-equivalent, present discounted value, ledger item on the Asset-side of the Balance Sheet, of U.S., to municipality, to corporate, Treasury. Also, a net-equal tangible value swap of the pro-se Independent Inventor's IRS-governed Fair Market Value tax amortization deduction, said swap to U.S.A. Federal or other major municipality, providing Government a tool for Demand-side economic stimulus, of up to, over a fifteen year period, by distributing swap value as per capita U.S. taxpayer tax relief, or synthetic payraise, to targeted needs situations, or to. internal U.S. Federal fiscal nominal budget management.

### STATEMENT

I did not make this Invention in hire, or in express Government contract. I did not make it for or with collaborators/agent/attorney. All rights reserved by me, without countervention, appropriation, partition.

### I DECLARE

I am the sole inventor, sole lawful applicant and representative hereof. I presented to Offices of the U.S. Federal Government (and, to no other Nation or its Offices) mailings containing Description of this Invention, for consideration by the U.S.A. Executive Branch towards entering Agreement Contract to License/Buy/Engage this Invention and/or my Intangible Assets and FMV tax facility. I commenced mailing on or about December 2009, interim mailings, to my USPTO filing, mailing Date of Dec. 8, 2010 by USPS Express Mail from 92004. I have received no contract to sign or any payment at all. Original Date of Feb. 26, 2011.

### BACKGROUND

Beginning with my first patent application, in November 1996, I have pro-se independent invented and authored in entirety, as well as filed, corresponded, responded, claimed and prosecuted over 300 inventions, generally bonafide, at the United States Patent and Trademark Office (USPTO). Starting with Oct. 31, 1989, I have registered copyright on my Works of Authorship, sole Author in Entirety of the Totality of the Works, at the United States Library of Congress Copyright Office (LoC). Throughout my seventeen years as filing independent inventor, I have typically registered my Copyrights on my Patents and Patents Pending, and, in receiving Registrations concurrently, have doubly-attested, and reciprocally, been doubly-attested, with USPTO and LoC, as the sole and actual inventor, author and owner of my Works (Intangible Assets), moreover, have earned and gained protection of my Rights and Entitlements in both patent and copyright arenas, wherein, in second case, my Rights/Protections are worldwide, long-term (my death plus seventy years) and cover my mathematical formulae, coded algorithms, compiled computer programs and spreadsheet software, in addition to text, drawings, music, art, composition, performance, recordings. I am born with genetic handicap disorders of severe terminal class, and have far outlived typical lifespan (dead by puberty). I have two rare metabolic-mitachondrial disorders, and, likely, internal bleeding genetic hemophilia. For years now, grave disabled, in the disorders' “final stages”, I have labored alone. Still without any licensee signed or royalty received, I made O/CPLT.

Having terminal-class handicaps, with many signs far advanced, and, having no family of my own (natural heirs of a wife and children), and having no contracted licensee paying royalty for my Works, I needed to create a Will, or descendency, method for my Intangible Assets, especially as, much of my valuable Works are formulae and algorithms with substantial (global, death plus 70 years) protections after lifetime, and also, because, in discussion and work-up with the Internal Revenue Service, I (pro-se independent inventor, author, owner) was granted, in 2005, a valuable personal, individual, Fair Market Value-based, fifteen-year straight-line tax amortization deduction facility, which instates and is usable against royalty I earn from my Intangible Assets (I have never received any royalty to date (Feb. 17, 2014), nor have I relinquished my Rights (everyone is expressly prohibited from use, commercialization, distribution, etc., of my inventions, authorships, music, etc., by Law). Thus, in two manners, Offices, Authorities and Auspices of the U.S.A. and World have examined and determined that my Works have value and usefulness: on the one hand, as Intangible in nature, having novelty, industrial application and usefulness, by the USPTO and LoC; and on the other hand, as Tangible in nature, my labor, creativity, dedication, productivity and innovative gifts and efforts, meriting that I hold a tangible value (actual nominal) Fair Market Value tax facility. These two accrediting and examination Authorities are counter-parties thereunto, bona fide, legitimate value of my Works.

So, the attestation parties of the U.S. Government, respective Intangible Assets, A) Intangible merit of the works—the USPTO and the LoC; and B) Tangible merit of the works—the IRS, both have certified my trove of invented and authored Works as well meeting standards—being of and for economic, business, commercial, investment, development and industrial value. However, were I to die, yea as is, without contracted, royalty-paying licensee (of preferably three or more years of reliable periodic royalty payment history, comprising “business”, or “in-business” standards of IRS and banking), and, without receiving royalty, then, my IRS-granted FMV amortization deduction facility does not come into realization, and, importantly, if I were to perish, all and any opportunity to contract licensee, receive royalty payment three years, have enabled FMV facility ongoing, are lost, and forever after cannot be enacted. On that basis—and such is the state today still, Feb. 26, 2011, (ed. still, as of Feb. 18, 2014), everyone (any person, group, company, government) is wholly and expressly prohibited from any use or commercialization of my Works, and all my FMV opportunity perishes. In neither case, then, would any opportunity, protection or use or value be able to pass onwards at my death. A patent, or copyright, without a royalty-paying licensee, in the words of the IRS, has “actual nominal value always equal to zero” (for it is the royalty-paying contract that has value—its absence; at death, precludes any heirable Work—matters of zero value cannot be heired, used as collateral, or be collected on). The FMV tax facility, by Law, is personal, and cannot be heired, even by wife.

What happens at such untimely death, is, that everyone remains prohibited, without chance for contract, until 20-year patent term, and death-plus-seventy-years copyright term conclude. No one heirs them (they have zero nominal value at death). The FMV facility expires as I do, unused and its value closed off, also not passing onwards.

This set of laws, circumstances, made me worry—my tens of thousands of hours of labor I invested. The great knowledge, tenacity, I used to create these inventions, rights and potential values—all could vanish if I died—worse, the World and the U.S.A. would be prohibited from using my Works. By the scope of my Works adoption by industry, even though as infringement or plagiarism, these are very valuable rights and FMV that should not simply disappear. Hence, I crafted and structured a financial license transaction which optimizes and maximizes at each juncture real and actual nominal value in and for the U.S. economy, conceived as a license contracting so that, even after my death, the full nominal creation and capture of economic value for and in the U.S. economy, for, with and to the industries and People of the U.S.A. In that manner, capitalism and the world economy would be served.

### TECHNICAL FIELD

My invention structures financial processes and methods, comprising accounting, asset and liability bookkeeping, royalty payment and investment asset underwriting, taxation and licensing matters, incumbent to the items termed intangible assets, such typically including intellectual and copyright properties, patents, inventions, trade secrets, works of authorship, musicianship, artisanship, also, formulae, mathematical equations, algorithms, computational codes, computer software and spreadsheets. Separate hereto are other intangibles of goodwill, franchise value and name.

### SUMMARY

### Brief Description Of The Invention

My invention, structuring Intangible Assets (IAs) for book maintenance, accounting, credit examination, investment, payment of royalty, provision of use license and tax deductions, starts by transforming IAs from the Liability side of the Balance Sheet, to the Asset side. This comprises the invention's first inventive step. In traditional accounting, IAs are placed on the Liability (right) side of the Balance Sheet, because, often, payment of royalty is made to the inventor or owner of the IA. In the case of a corporation with its own Research and Development, the creation of an IA may be internal to that firm, and also, possibly without any fixed royalty paid vis-a-vis the IA, yet, the IA, in bookkeeping, still stands on the Liability half of the Balance. Yet, in this second case, the company, having made the IA, thus owns its IA, and uses it in its business for its value.

Compared to European financial statement practices, the American practice has aspects which create lowered safeguards, slowed enactment of safeguards, and muddled functionalism between components, all of which can serve to reduce the actual, apparent or impression of a company's credit rating, financial security or solvency, and ability to borrow or attract shareholders. One of such area is Intangible Assets (IAs). Because an IA, on American books, is placed Liability-side, it often requires reference or writing as Off-Balance Sheet item. Off-Balance Sheet items, and the footnotes, and sometimes convoluted arrows into other components of book, defacto, obscures accounting, which in turn is devalued be examiners issuing credit grade, as well as de-motivates potential buyers of the company's stock or bonds. Dependent on the origin and ownership hold of an IA within the company, such as being an asset it directly created and owns, its placement into Liabilities is clearly opposite its nature, and has led the Balance Sheet component of IAs to be toward a slush field on book, juggled to meet requirement that company Assets equal Liabilities. Typical Assets on a Balance Sheet are cash, cash-equivalents, real estate owned, capital equipment owned, etc. Also, the net of company treasury is reflected, comprising its portfolio of cash, stock, bonds and government securities it owns. Because an IA can be sold, can be leased/rented for a periodic return and carries a value in its Rights and Entitlements to use, to permit and to prohibit, my Invention structures IA as Asset on Balance Sheet, and moreover, as having inherent value, enabling a security to be underwritten with the IA as its basis. In first step, the IA is levered, or provided, up to an underwriter, in this case, the U.S. Federal Treasury, which issues Treasury bills, Notes and Bonds, as well as backs a wide assortment of securities with varied bases, such as real estate. In this case, a Treasury Asset is made by the U.S. Treasury, whether with purpose to be traded openly or at all, sold to the public, or held internally as a core stockhold of the U.S. Treasury, much as the U.S.A. holds gold, which aids it to float new Treasury issues at auction. Moreover, as each IA has a specifically attached set of rights and entitlements to use, license, manufacture, for instance, a specific invention, that set of Rights and Entitlements is held by the U.S.A., at Federal level, and can be directed, implemented, rented or sold, as part of a publicly-issued security, as an enhancement to existent security, or a simple a transaction of the Rights and Entitlements, without any financial fixed-income instrument body. In my personal case—an example of my invention CPLT embodied—of IAs which are virginal, not licensed or transacted, or invented elsewhere, the Nation, U.S.A., can obtain top-down use rights, adding the IA as asset to the Federally-held wealth. In the case of a corporation with different IAs it holds on the Liability-side of the Balance Sheet, with and through levering to the U.S. Treasury, that corporation can retain its IA, but on the Asset-side cleanly, in the form of a U.S. Treasury-backed Asset.

The following cases of Treasury Asset apply:

1) virginal IA is up-levered to U.S. Federal Treasury inclusive of its Rights and Entitlements;

2) IA bearing a royalty contract of promised payments is up-levered to the U.S. Federal Treasury inclusive of its Rights and Entitlements;

3) IA of a corporation, booked on the Liability-side of the Balance Sheet is transformed to a financial security of the Asset-side by up-levering the IA to U.S. Federal Treasury or other securities underwriter, retaining its Rights and Entitlements.

In so far as transferring an IA's Rights and Entitlements to the U.S. Treasury or other underwriter, royalty payment to the inventor or owner of the IA being transferred can be variously structured, as, eg. interest-only (STRIP), one-time cash-out, E-type zero.

While it many be theoretically possible to co-package almost anything together with the IA's Rights and Entitlements, the obvious attached package of basketed values, is the Royalty/License Fee component, in exchange for transferring the Rights and Entitlements of the IA. A second, rare, basket of values directly attacked exists in the case of a pro-se (by oneself, for oneself, without attorney, agent or affiliate) independent inventor (not in hire, nor salaried employee, or in specific Government contract, in the act/practice of inventing), such as myself, but only with and by permission of the Internal Revenue Service (as of 2005). This set of values, I call Savings, and it formally is the Fair Market Price of the Royalty created by the pro-se Independent Inventor, bundled together as aggregate of the patent life basis, discounted to present value, wherein, that discounted aggregate serves to establish the tax deduction which the pro-se may take against royalty actually received, on a 15-year straight-line amortization basis; divide eg. by 15.

As of 2005, only a pro-se Independent Inventor could be granted by the Internal Revenue Service a tax amortization deduction based of the Fair Market Value method. Generally, a corporation (or dedicated invention business, fully funded) has fully itemized components contributing, by line item in actual nominal amounts, to the corporation's inventing activity. Such include, scientists, researchers, receiving job salaries, laboratory, real estate and equipment fully scheduled, attorneys and staff writers, draftspersons and typesetters completing patent filing descriptions through to prosecuting a patent application to issuance with accepted claims. These itemizations (not fully inclusive) are the corporation's cost of inventing, and along with depreciation of IA schedules, comprise a company's IA accounting, deductions. For a pro-se Independent Inventor, there are no itemizations, of the inventing itself. While the USPTO does charge fees for filing an application, as well as other fees at steps through to patent issuance and maintenance, these fees are those associated under cost of patenting, and at that, are paid to the USPTO to review an application. Essential, then, is to understand, the FMV deduction is used, due to absence of itemized inventing costs, and pivotal, that the FMV deduction is granted to a inventor, a pro-se Independent Inventor such as myself, who is a person, an individual, with the FMV deduction made on the inventor's personal 1040 Schedule C, ‘other’. Conversely, the FMV deduction is not attached to any, or to any specific, IA. The FMV deduction is of human inventing, a personal, non-transferable, non-salable nature, not inheritable, and is only usable by the inventor when and against royalty received.

To repeat: I was granted by the Internal Revenue Service, at meeting in first-half 2005, permission to use the FMV tax amortization deduction, against royalty (or other IA-related) income, should or when I receive it. I am a pro-se Independent Inventor. One cannot assume that any pro-se can use the FMV method, for it must be formally (written) permitted by the IRS. Likely, it is more reserved for pro-se's who are ardent, long-time inventors, and whose Works are of profound market impact, consequence and value. Be that as it may:—following on my invention of the Treasury Asset process (12/09 to 4/10), I considered that, in the event I receive royalty as interest payments from the U/S/ Treasury (whether as a full par, face-valued, fixed-income instrument with periodic coupon, or not), interest (rate) payments from U.S. Treasury are tax-free to those who receive them (standard feature of U.S. Treasury instruments). Thus, I said to myself, I would not need to use (much) my IRS FMV tax amort deduction, as I would not owe taxes on my royalty if paid from U.S. Treasury. Fantastic, I said, that may enable me to use my “Savings” (FMV) value elsewhere—like, to help Our Government have additional money for Our People and Our Budget. So, I invented a second process, “net-equal value swap with Civic”. Background: two parties may swap with each other like assets/earnings/value (such as real estate), and their taxes in tow (their net) as long as, at each end, approximately equal value is netted by each party. A swap, a legal financial maneuver, requires that net-equal value guidelines be enforced, that swappable is like, and parties, appropriate.

In addition to my Intangible Assets, list provided in figure, I have a tax abatement=my FMV tax amortization deduction, granted by the IRS. A tax abatement has a useful, nominal actual value, against general income, about 1:3 (tax rate 30% to 35%) person or business. To result as net-equal, divide both ends by two and its capture is about 1:6 (one to six). If there was taxable income of $100, and we (USA & I) desired to swap to get net-equal value:
USA has $100, tax 1/3 : $33 tax due;
Swap: USA gives me 1/6: $16, I give USA $33 tax abatement;
Result, instead of USA paying $33 tax, USA pays me $16 and my tax abatement ($33 used) pays USA tax.

These conditions pertain to any swap I can do with my specific (inventor's) FMV, which pays each year for fifteen years:

1) I must receive royalty each year in order for it to become enabled that year—if USA Federal Government up-levers my IAs to Treasury Asset, said TA pays me royalty as income from U.S. Treasury;

2) Royalty need not be from U.S. Treasury, however, U.S. Treasury income is tax-free, thereby facilitating all of my FMV for Swap;

3) my FMV deduction facility calculates as very large (min. about $160 Billion per annum) each of 15 consecutive years from onset, hence, appropriate party to swap should be very large economic municipality, since my FMV is from the IRS/USA, it would be a very appropriate Entity;

4) my Swap value is tax abatement, hence, following structured process: O/CPLT [Our(USA and I)/Counter-Party License Transaction]: if USA licenses/levers up my IAs into Treasury Assets paying me interest as royalty, sapping my FMV to U.S. Treasury enables Our President to give everyone a tax abatement, and not just once, for fifteen consecutive years, estimated at over $1,000 each year, possibly some to targeted U.S. Business. Due to National Franchise scaling, applicable swap rate is about 1:19, with my retention of my personal Right to run my own IAs' businesses. Without retention of Rights, about 1:15. Alternately, a large Municipality or Corporation might suffice.

In conclusion of the SUMMARY and BRIEF DESCRIPTION of the INVENTION, my said invention, IA/CPLT, “Intangible Asset/Counter-Party License Transaction” provides two independent inventions, both of which provide economic value to industry and to the Nation. First, the invention provides process transferring Intangible Assets (IAs) from a Liability-side, often Off-Balance Sheet item, aiding accounting transparency and general credit worthiness, ceteris paribus, to a Asset-side, on balance sheet item, when as packaged into a Treasury Asset, having top-tier asset strength, as a near cash-equivalent asset. Second, the invention provides a process converting a pro-se independent inventor's personal IRS FMV tax amortization deduction into, or through, a net-equal swap with large civic and municipal entity, such as the U.S. Federal Government, for ends producing a general per capita, or targeted business, taxpayer abatement, causing by increased retention of income and greater discretionary funds on hand for each recipient taxpayer—an atomistic-driven Demand-side stimulus to the Economy. This stimulus, of sustained fifteen year fiscal cycles impacts the consumption-focused industries of Our Nation, helping to spur increased purchases of consumer products and services, while informing the supply-side companies throughout the 15-year-cycle of consumer wants and needs, while also adding more revenue to the operations, so as to afford these supply-side companies with the wherewithal at the margin to implement informed transitions and management plans to best move forward with trends and other demand-side characteristics. The fifteen year cycle Demand-side stimulus, in consumption-focused industries—not industries of my IAs—provides excellent complement to the value my IAs provide elsewhere.

The principal value sectors of my invention, also entitled, “Our (USA & I)/Counter-Party License Transaction”, deserve summary, so as to appraise, identify and review the cost/benefit impact areas on related industries, economic and financial function, and the Economy's performance. Summary in outline form:

1) CPLT licenses a catalogue or collection of Intangible Assets (IAs), so that industries related to, and benefiting from the IAs, are formally permitted to use and production Rights, enabling industry. For License to be of business contract measure, the Inventor/Owner of the IAs, and the Municipal Entity (eg. USA), must sign, and, on signature, as well as periodic, Inventor is paid royalty by the Licensee, with three-years (of payments) being worldwide basis of business (contract) operation, solidifying Licensee's Rights to continued usage and production of IAs in event of Inventor's death. Should Inventor die, with IAs unlicensed, signing and contracting Rights is no longer feasible, and IAs, value zero absent paying contract, cannot pass to heir or Licensee on death.

2) Inventor always has intrinsic, inalienable Right to use and produce one's own IAs, even if inventor has licensed them to a industrial user or municipal entity. In CPLT, this safeguards the National Government, assuming a booking fee is paid the inventor, as, in event of poor performance by an industrial sub-license, the Government, via Inventor, retains option and ability to add, license-fund, other sub-licensees. Similarly, in the event the USA wished to sub-license a foreign Nation or company, the USA, paying Inventor retainer, can hold or effect option to use and produce the IAs domestically.

3) By up-levering IAs to the U.S. Treasury, per O/CPLT, the USA gains core value in central reserve, which can assist fiat issuance, can be stacked onto U.S. Treasury instrument to enhance financial nominal and Rights value, or be refined as an IA-based Treasury Asset. Payment to Inventor of IAs is warranted, as IA sweetens U.S. Treasury.

4) Providing specific operating industries, or specific companies within industry sectors, licensed use and production Rights of IAs (the IAs industrial applicability and usefulness already is examined and ascertained in the USPTO patent search, examination and issuance process) aids the competitive, opportunistic and financial goals of these industries and/or companies. Whereas typically a company might individually license an IA from inventor directly, which usually contractually operates to exclude and prohibit all other economic participants from use and production Rights, and, hence, Licensee pays Royalty to that Inventor, by O/CPLT, USA Federal Government can multiply license, some, many, or all, companies within an IAs industry, thus, greatly expanding the usability and production domain of the IA in the economy, and thus, multiply effecting production, savings and profitability economics and improvements within Our Nation's Economy. As licensees of the U.S. Government pass-through of the IA use and production Rights, the IA-recipient industries and/or companies (sub-licensees) properly under intellectual property contract law, would or should pay royalty to their Licensor (the USA), in turn, ultimately to or under Inventor, by, given mandates, desires and initiatives by Our Government to stimulate business success, the USA may elect to forgo royalty fee collection, judging the Nation's Interest is assisted, as the sub-licensee's Rights to the IA, improve its outlook, stability, job base, profitability, growth, return on equity, and taxable revenues, which operate as returns for Nation. Thus, the consolidation of IA at U.S. Federal level opens up the dispersion of IA Rights, and supervision thereof, to comprehensive means.

5) The invention herein of a Treasury Asset (TA) is remarkable in the functions it serves, and, unique in the world of finance. In order to simplify matters of royalty to inventor of the IA, in licensing up to the U.S.A., to U.S. Federal Government direction, for distribution, restriction, permission and prohibition, and supervision, and collection of royalty, as It sub-licenses the IA into and among the industries, and specific companies comprising industrial sectors, the Treasury Asset carries use and production Rights. The magnitude, nominal, of the Treasury Asset can readily be set as determined by the annual operating revenue, devoid costs, of the industry, or of specific company—at least with respect to operational sectors in which the IA has import and brings value added capabilities to performance. Thus, in sub-licensing an IA, the U.S. Treasury and/or Department of Commerce, in work-up with sub-licensor, stamp license certification upon this U.S. Treasury-issued Asset, as well as Economic/Revenue Scope (an approximate magnitude). This latter number does not confine or appraise the TA, but is a book-item (Face Value) in database, along with the name of company and IA Rights. Should the U.S. Treasury/Commerce and Executive wish to charge royalty fee, this fee likely a percentage rate applied to the Revenue Scope, aka Face Value, is periodic rate due in advance, at outset, for use Rights of the IA during the period being entered. Also, on the TA, will be determination as to whether the TA is transactable by the Sub-Licensee, such as whether it has the private right to sell or to sub-license the IA (likely not, without consultation with USA), and if so, at what rate or amount. Also, whether Revenue Scope can be partitioned. Clearly, TA has value, real value. TA pays Inventor and U.S. Treasury. Hence, in distributing and dispersing use and production Rights of the IA, the U.S. Treasury and Its Assetholder on behalf of Our Commonwealth, the Federal Reserve Banks, the FRB, via Treasury and commerce, bookkeeps matters. On the one side, the IA which an inventor has levered-up to USA for use and production in the Nation. Bi-lateral signed contract specifying terms, contents, payments, etc., is executed between inventor and Nation, to initiate. On other side, the industrial operatives of USA Executive implement discussion, strategy, tactic, negotiation with industry sectors, leading corporations, companies therein, and, use and production Rights are passed along to specific industries and/or companies via the Treasury Asset. As royalty is due, technically, must be paid inventor to constitute a valid license, and permitted licensee, or sub-licensee, it is efficiently accommodated via the TA, wherein royalty for IA is consolidated, received, aggregated, distributed. A minimum rate is contracted, promised, the inventor, payable by and guaranteed by U.S. Treasury. Based on U.S. policy, the licensed industry, industry leaders/companies, will receive sub-license (under USA) gratis, at charge fixed, or by open bid or auction (where exclusive or sub-licensing Rights may be part of TA). Sub-licensees(s) pay periodic to U.S. Treasury. U.S. Treasury pays periodic to inventor. The aggregate, specifics of each, Treasury Asset, is kept on book at U.S.T/FRB. Any trade, alteration, periodic appraised of Revenue Scope, is pre-advised and recorded by UST/FRB. The aggregate of all TA, and royalty revenue in-coming to USA, is counted. To keep matters under clear, uniform, comprehensive monitoring, recording and purview, the center asset, the IA, hold is also center of asset issue, with recording of specifics and any modifications, as well as banking and payment record of royalty, as a timeliness, are all the FRB/U.S. Treasury system. As one-stop royalty receipt and payment center, all TAs are recorded, and royalty payments received (as applicable) documented. And all up-levered, contracted, IAs are recorded, and royalty payments made documented. Hypothetically, an inventor might be guaranteed in contract the U.S. Treasury payment of one or two percent, per annum, multiplied by the aggregate Revenue Scope (aka Face Value) licensing the inventor's IA. In addition, on Royalty received from industrial licensees, all royalty income in excess of two or four percent, respectively, might be split 50/50 between inventor of IA and FRB/UST of TA—with the next one or two percent, respectively, going to the FRB/U.S. Treasury. Royalty of sub-licenses has its own consideration—hypothetically, if industrial company sub-licenses at 3 percent annual times Revenue Scope, then firm text, dividing each of company, FRB/UST, and inventor, with one percent each. Point being, inventor of IA (by Law) requires being paid royalty. TA process enables fantastic, tailored dispersion of use and production Rights into Economy by prime Licensee, USA, and Its Agencies, the U.S. Treasury, FRB, Commerce, Executive, and, in dispersing/sub-licensing into industry, can earn royalty Itself. Under bid or auction for exclusive Rights, moreover obvious. And that inventor also benefits thereof. Ultimately, TAs can trade, restricted, but a Fair Open Price.

6) By way of the Treasury Asset (TA) issuance of Licensee Rights, each TA carrying a revenue-impact value, as well as a royalty rate charge (if none or little, then, USA People are subsidizing Licensee, which is to be remembered, and considered, before subsidized Licensee contracting). Nonetheless, on the basis of summing together all Revenue Scope (aka Face Value) numbers for a given IA, the sum aggregate gives an economic indicator of the Market scope of that IA, and, irrespective of whether a real royalty rate is charged industrial Licensee or not, it is a fair indicator. On that basis, once mature (licenses in place), the aggregate of all Revenue Scopes for Licensees of a given IA, is a Fair Market Value of the IAs' market, applicable market(s) of impact. Similarly, the aggregate royalty income which the inventor receives from FRB/UST on his/her IA, divided by a Fair royalty rate governing payment (i.e. minimum contracted floor, plus paid or phantom (subsidized) additional royalty rate), determines the Fair Market Value, of importance in calculating (any) applicable inventor's IRS FMV tax amortization deduction. Thus, (see FIG. 1F), an equivalency exists, and can be used to evaluate, conjecture and approximate both the Treasury Asset market for an IA, but, also, for establishing the Demand-side stimulus available, via net-equal swap, by calculating the FMV tax deduction—for both link to, and work to inform, the Fair Market Value of an IA, wherein, FMV determined from either side should concur, or can, if need be, used in lieu of a determination not forthcoming on one side. Hence, to determine the Fair Market Value (FMV) for an inventor's personal IRS tax deduction, assuming herein said Intangible Assets (IAs) containing copyrights (protections worldwide, death plus seventy years), having capacity to lever-up Treasury Assets of centarian (100 year) term nature: it is the Present Discounted Value of the sum of the 100-years of royalty rate applicable to the Treasury Asset of “Face Value”, Revenue Scope, PDV|¹⁰⁰EiTA_{FV}|, where i=royalty rate per annum, and FV=Face Value=Revenue Scope. That is the Fair Market Value of the Inventor's IRS personal tax deduction. For a case like mine, where I have created, invented, authored, filed, prosecuted and patented, as well as copyright registered, a vast trove of my own personal, individually independently invented, authored and owned Intangible Assets, in their Entirety and Totality, wholly and solely of my creation and ownership, and, also of my own personal inventor's IRS FMV tax amortization deduction—none of which I have contractually licensed (or sold) and received royalty payment, or, of my FMV facility, used, or even, had a chance to use yet, it may be for Our Nation, U.S.A., to consider the above-described, more general method for a single IA, which, in my case over time, will lead to phenomenal values realized financially and economically for Our Nation—Its Treasury, FRB, Its industries, corporations, People—as well as for me, or, it may be more expeditious for Our Nation to consider up-levering my Works in toto, as a single large bulk transaction. In the latter case, these six major areas of economic value-added suggest the bulk transaction. US pro-se sole Independent Inventor/Author/Owner.

### BRIEF DESCRIPTION OF THE DRAWINGS

Herein are Figures which I drew during the course of December 2009 to Non-Provisional Application filing, which I sent, sealed, by USPS Express Mail from USPS Post Office Borrego Springs Calif. 92004, on Dec. 8, 2010.

FIG. 1: United States of America—O/CPLT: IN ACTION.

FIG. 1A: Counter-Party Licensing Transaction, Sep. 20, 2010, describing Front-End License and Back-End Net-Equal Tax Swap.

FIG. 1B: O/CPLT: Our (USA and I)/Counter-Party Licensing Transaction; with Front-End License side-by-side, Amidst the United States of America centering, Back-End of my pro-se Independent Inventor's FMV IRS Tax Amortization Deduction, 15-year, as to USA, Net Value-Equal Swap to U.S. Per Capita, with Tangible Macro-Economic Benefits to USA Commonwealth and U.S. Treasury Asset/Liability Balance Sheet Improvement.

FIG. 1C: Front-End LICENSE DETAIL, Invention of Treasury Asset owned by U.S. Treasury, not Debt or Fiat.

FIG. 1D: BACK-END TAX SWAP DETAIL: Historicals FMV TaxDeduct=Amount, Treasury Asset Up-Levered.

FIG. 1E: My BACK-END TAX AMORTIZATION DEDUCTION NET-EQUAL SWAP, incl. Fair Market Value FMV is present discount value of Life of Royalty Stream Example: FMV of Treasury Asset and Net-Equal Swap.

FIG. 1F: FRONT-END, BACK-END, FMV EQUALITY.

FIG. 1G: ESTABLISHING VALUE FMV EQUALITY, and My BULK INTAGIBLE ASSESTS (IAs).

FIG. 2: TREASURY ASSET—U.S.A.—OWNED COMMONWEALTH ASSET; an O/CPLT Contract would Assign BULK MY IAs to USTreas./FRB.

FIG. 2A to FIG. 2I: O/CPLT

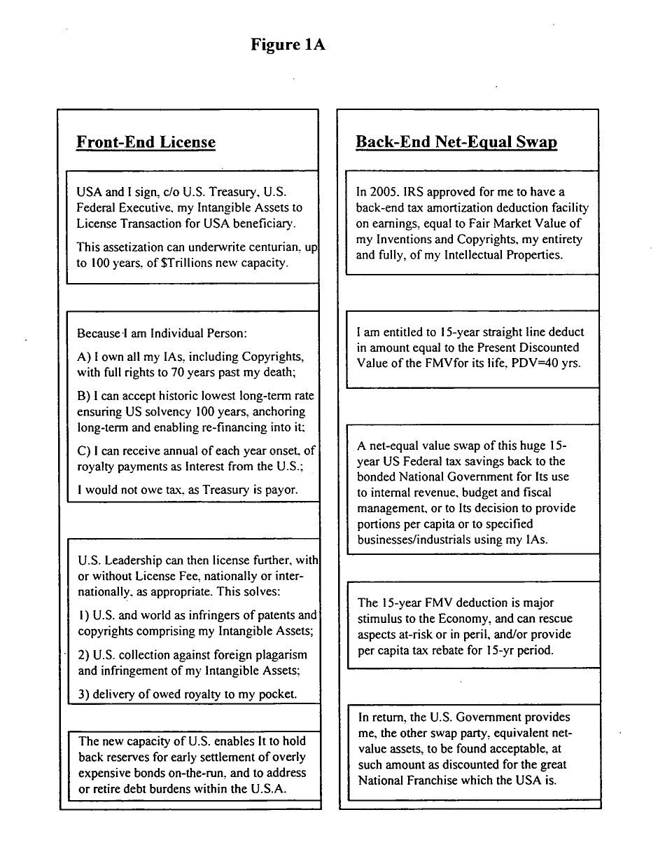

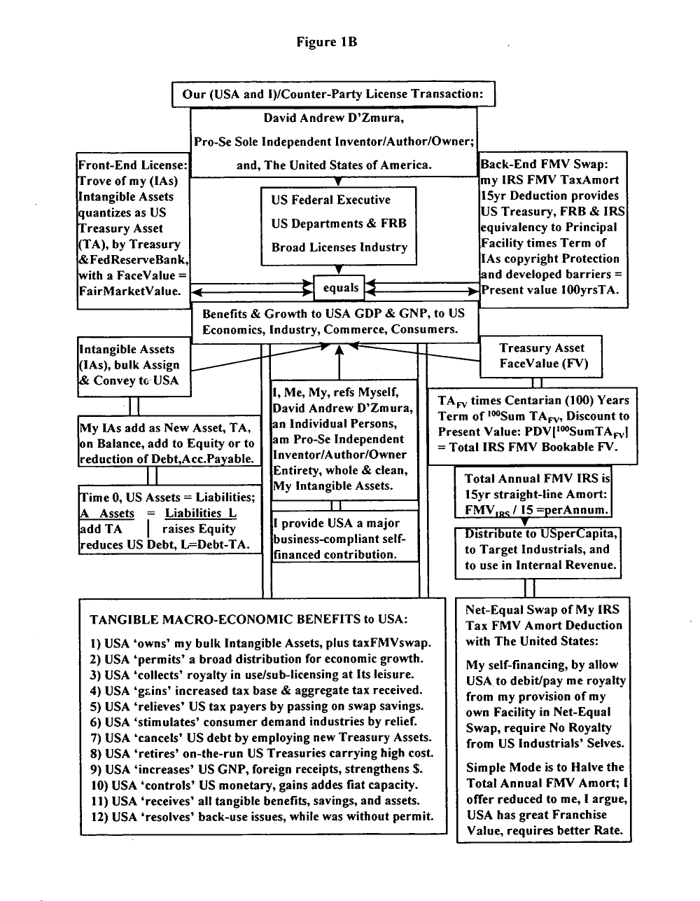

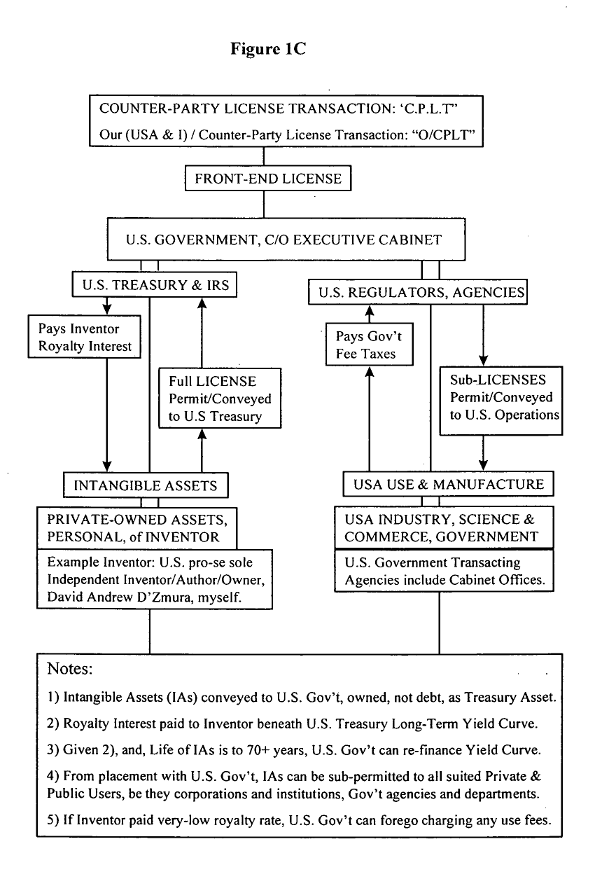

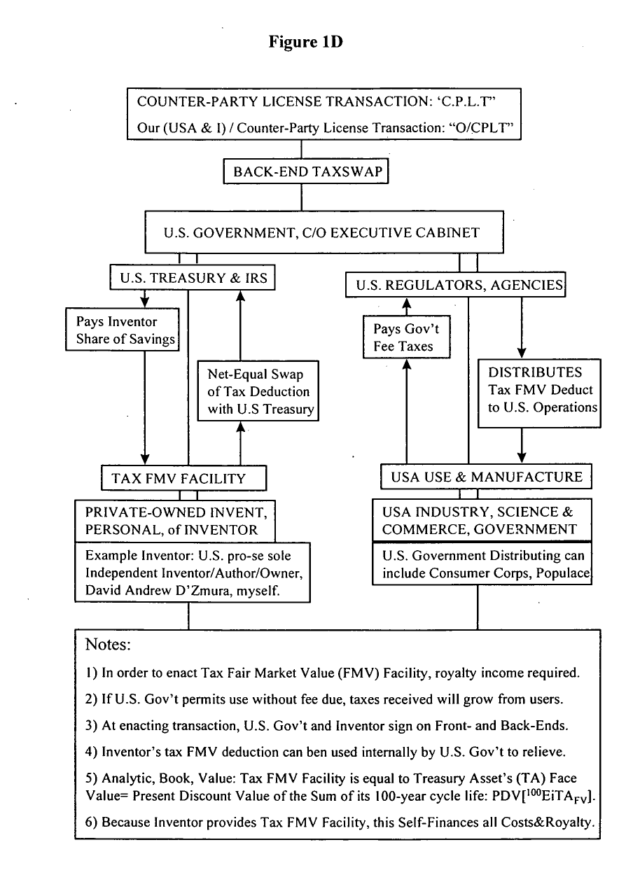

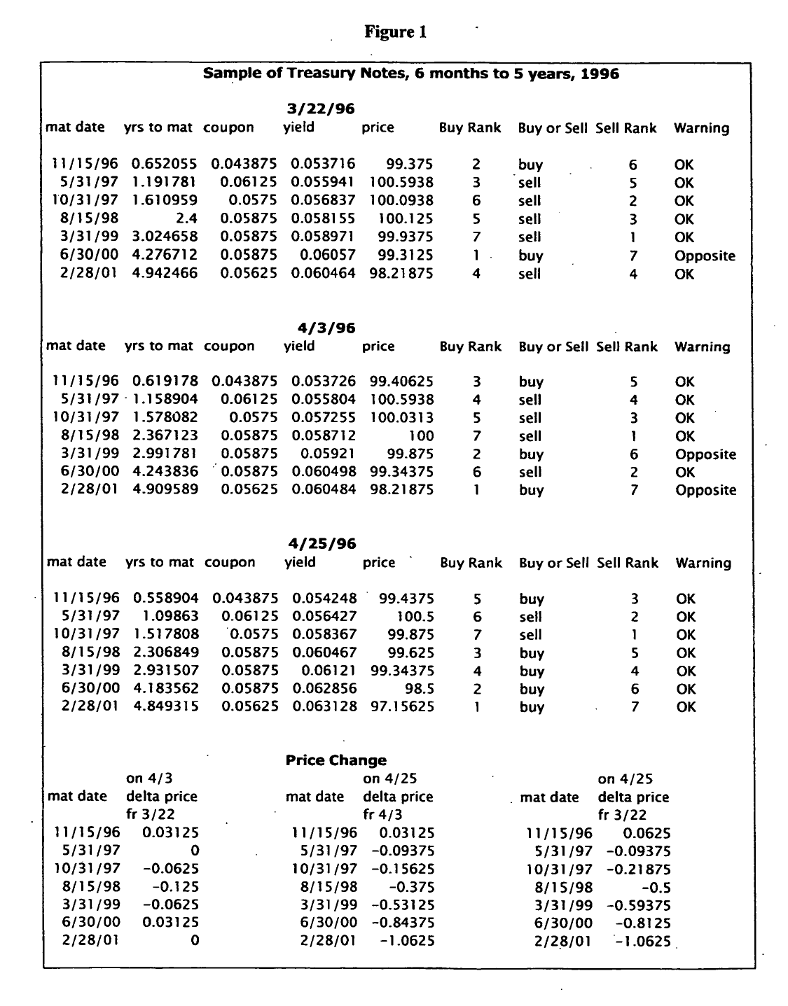

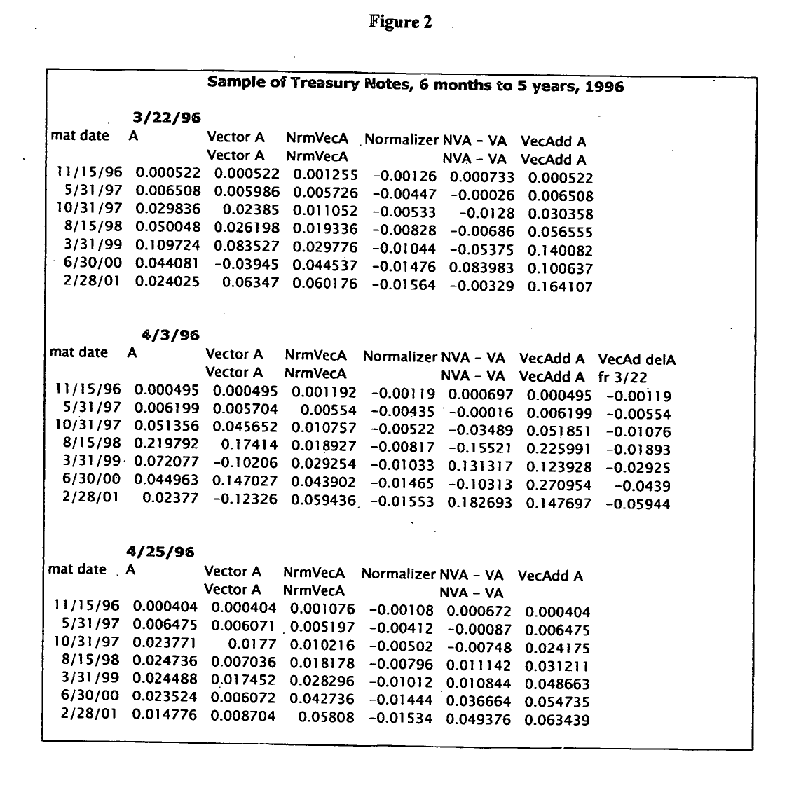

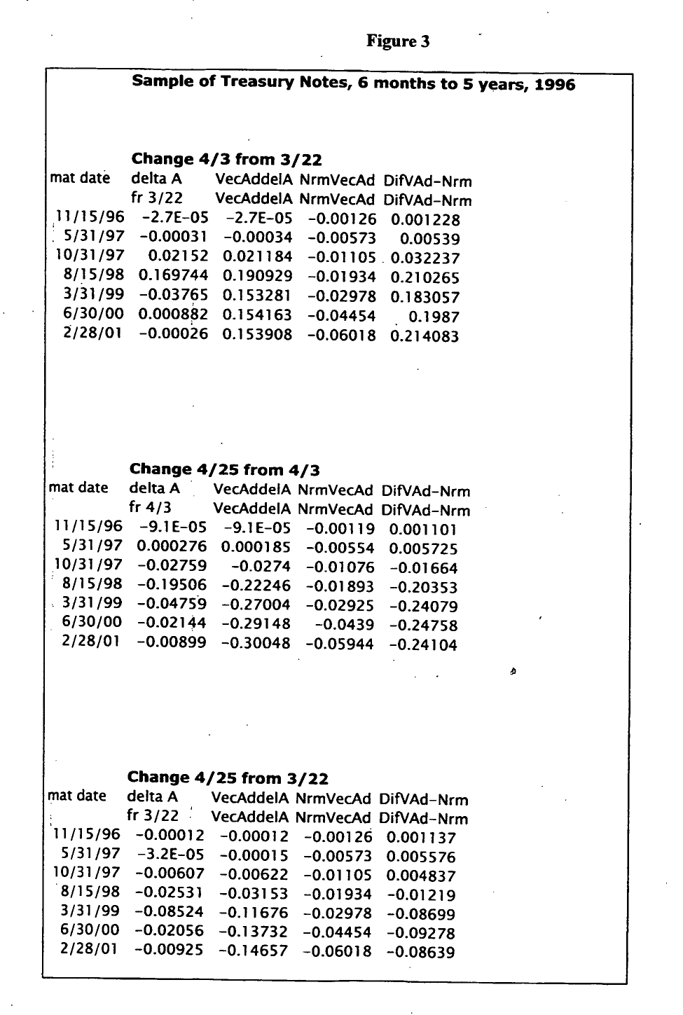

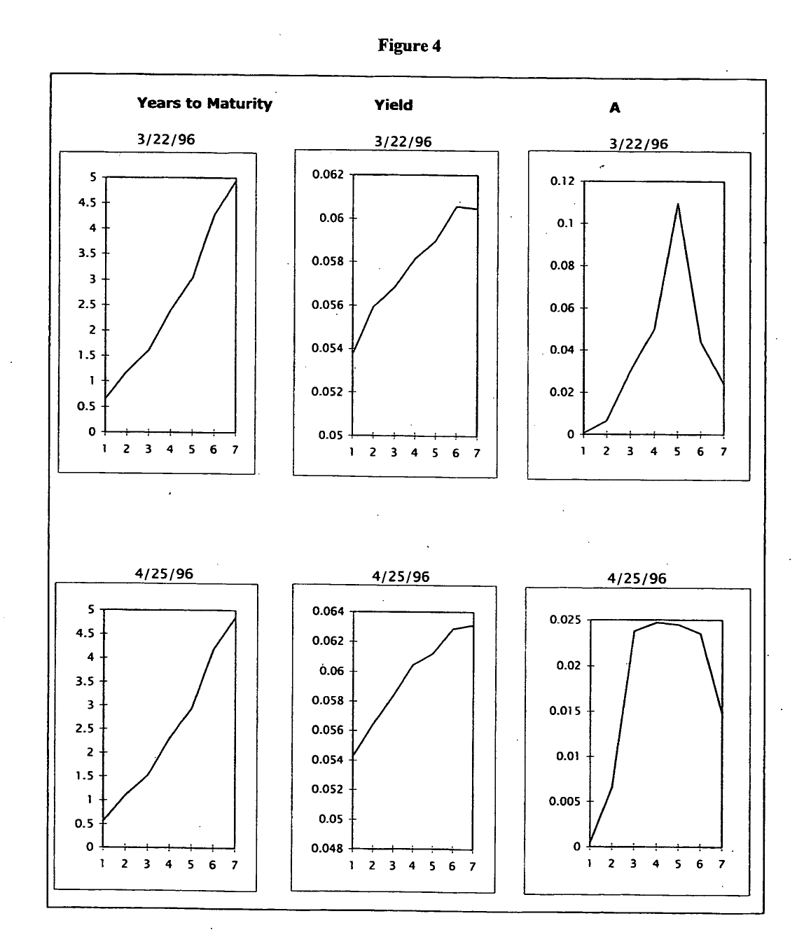

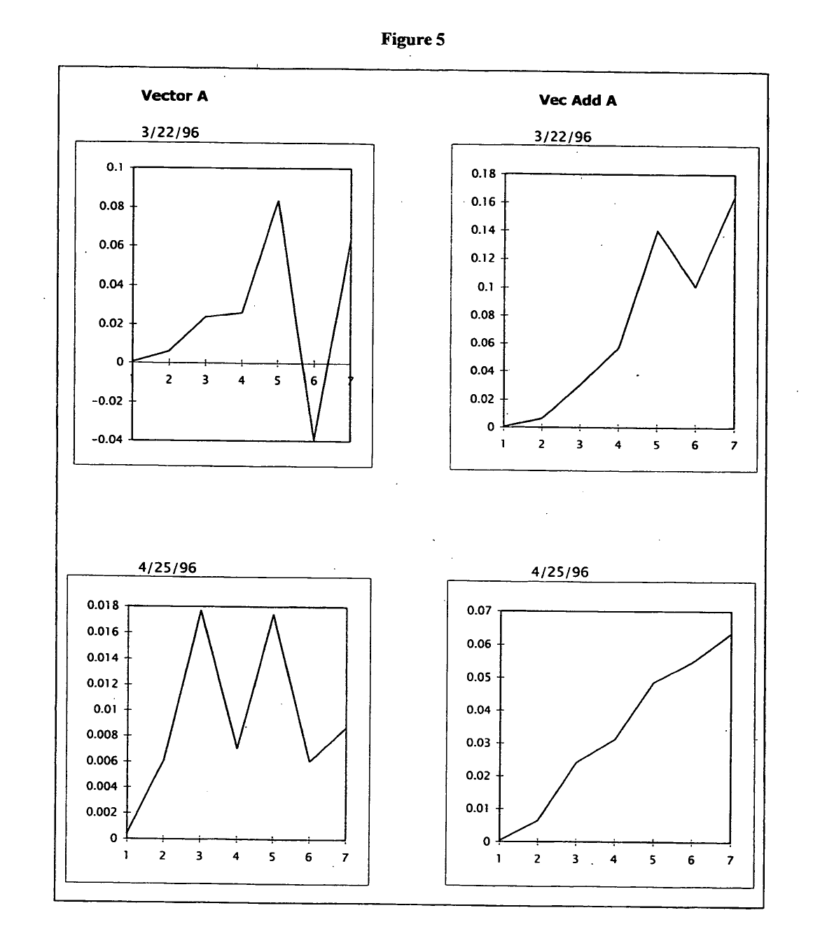

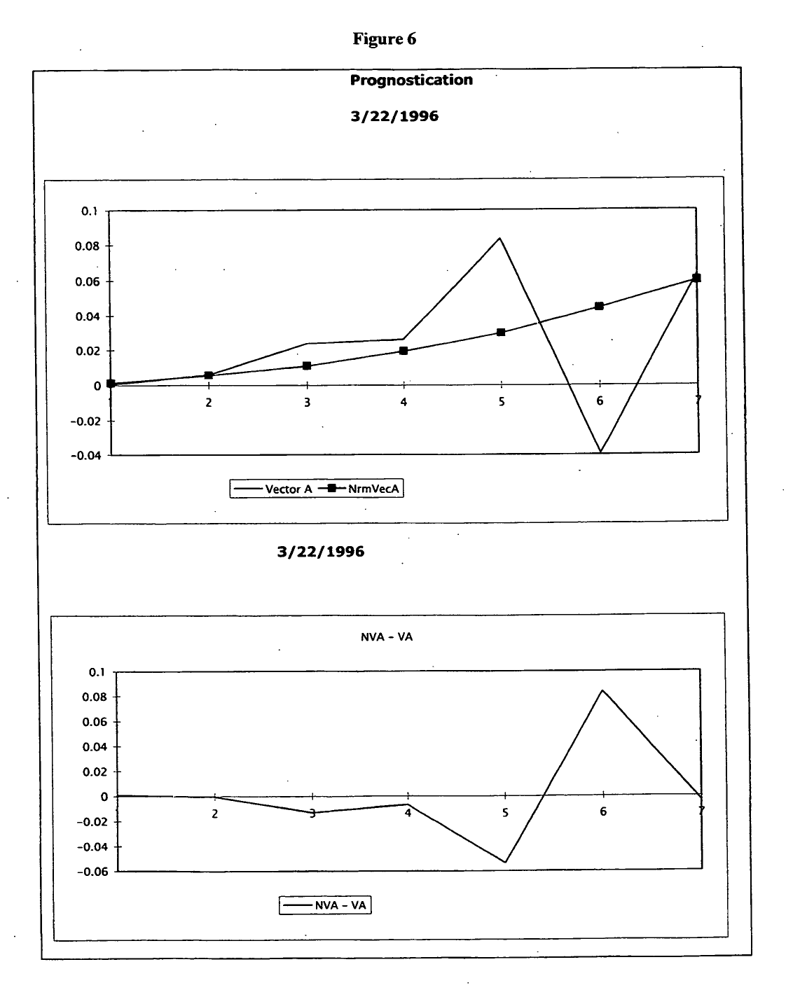

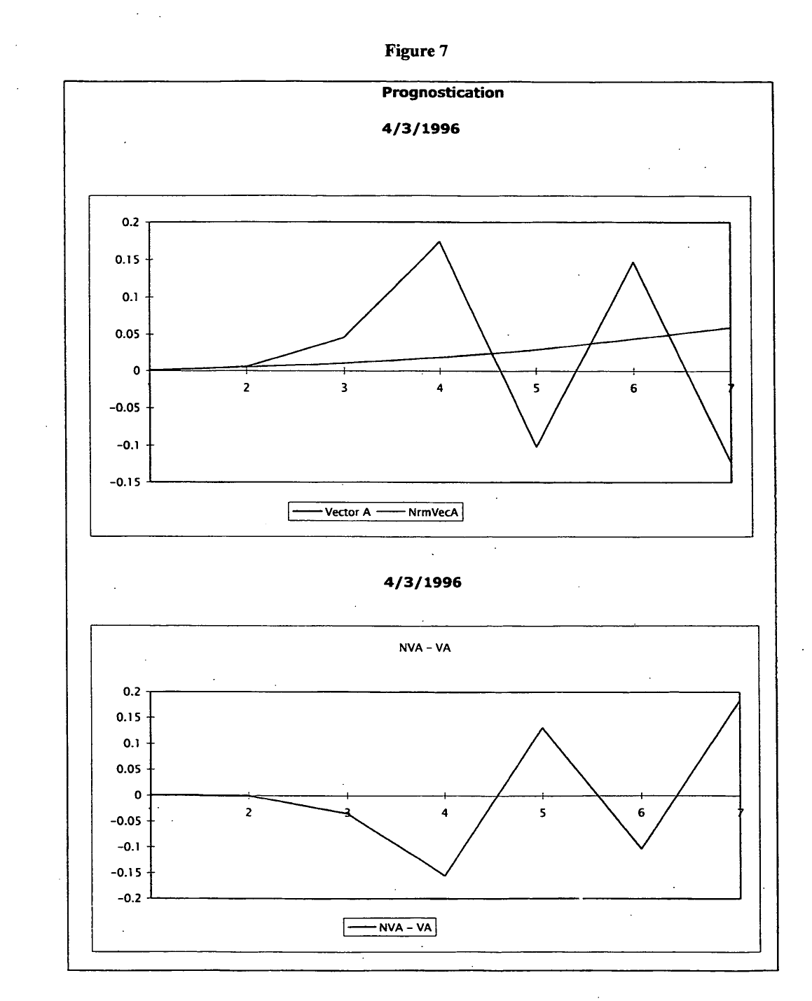

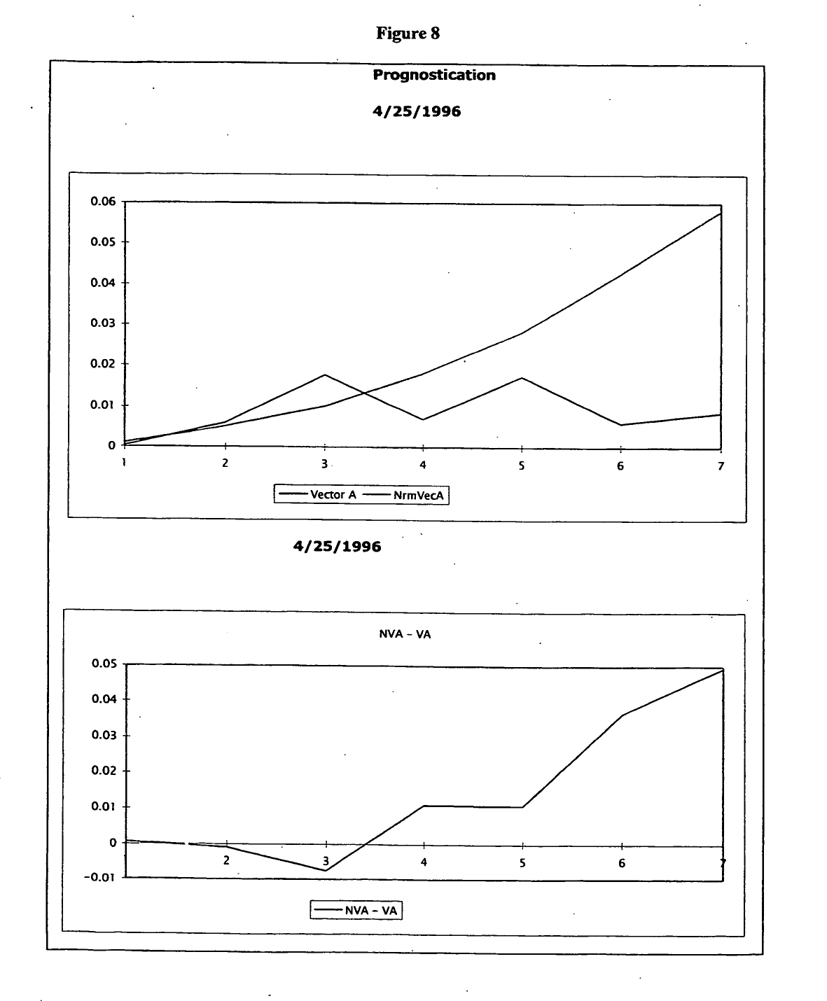

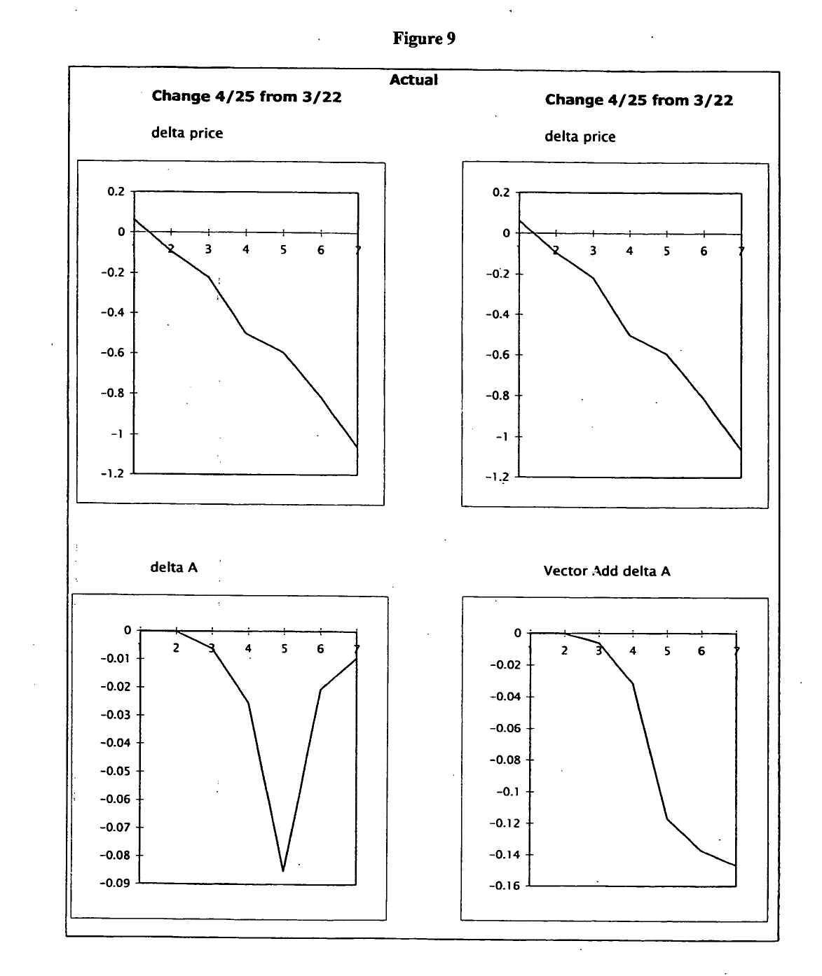

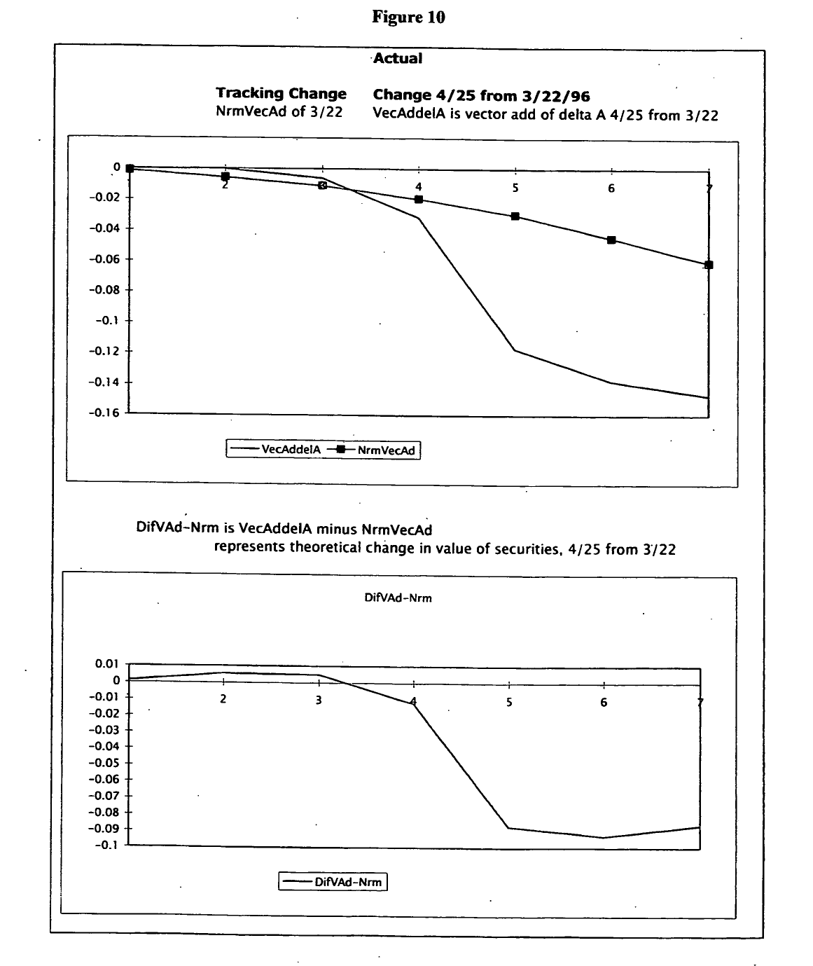

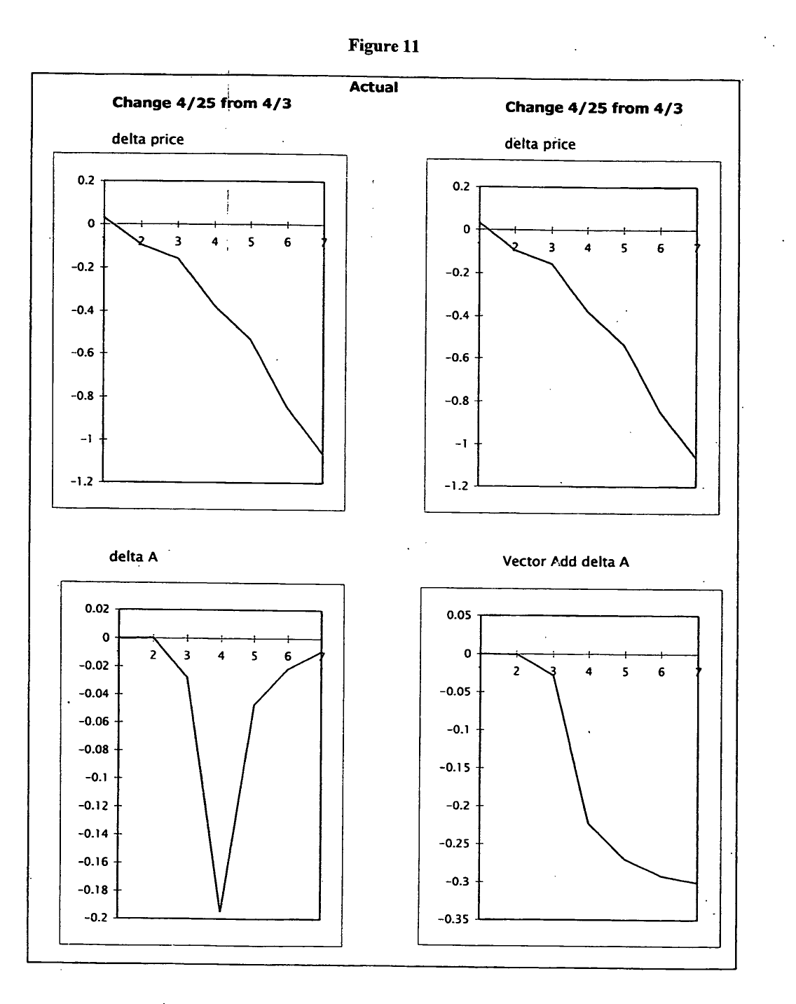

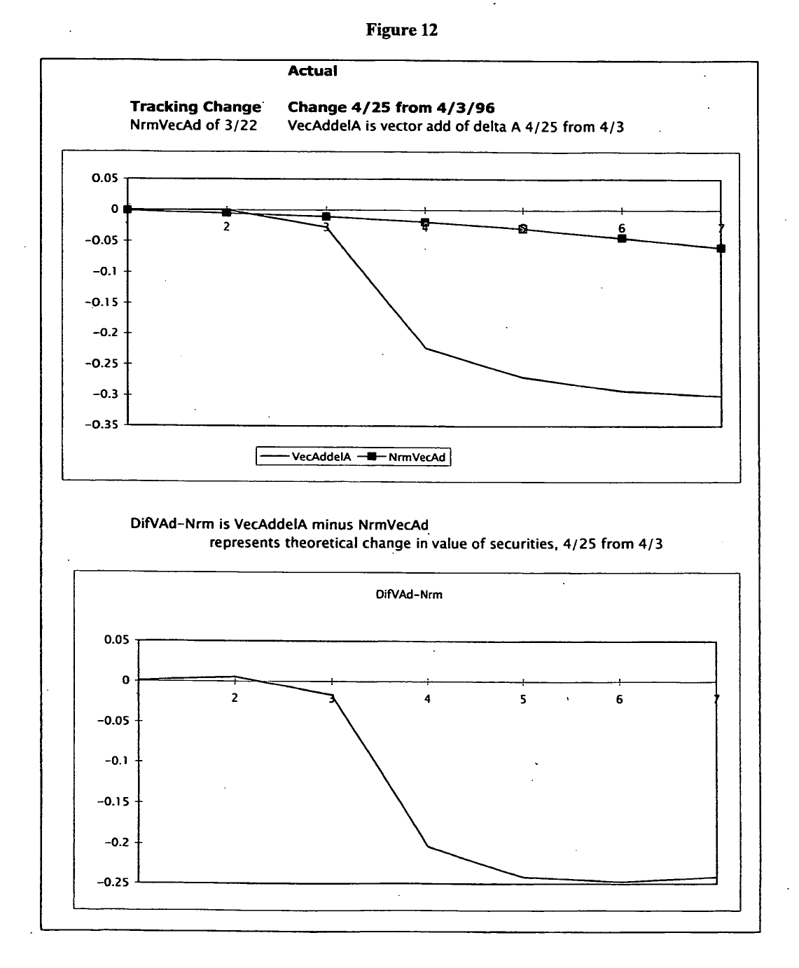

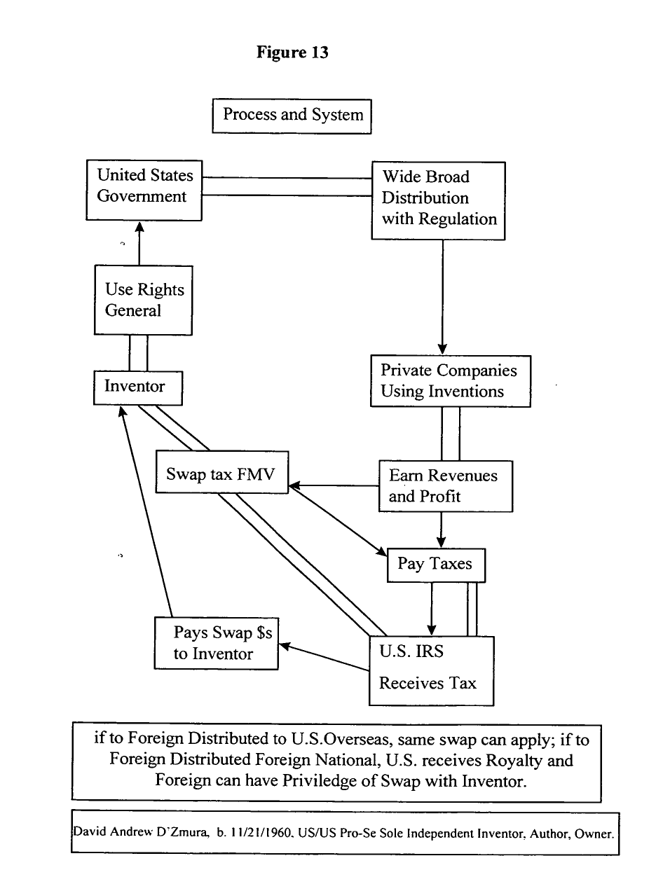

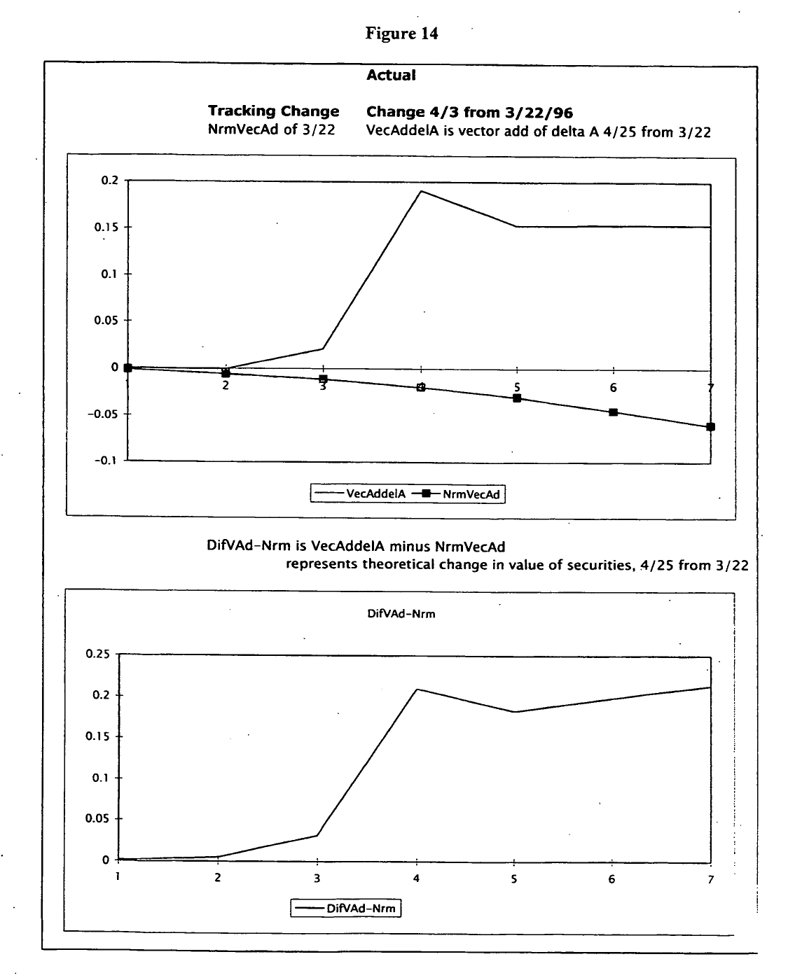

CORE BENEFICIAL ARRAY TO OUR ECONOMY:

A: 1) Licenses.

A: 2) Decriminalization.

A: 3) U.S.A. facilitated past my Death for Use.

B: 4) CPLT—Means to Up-Lever Macro-Applicable Intangible Assets.

B: 5) Up-Levers Intangible Assets into Cash Equivalent Assets; Major Inventive Step: IA Conversion to Balance Sheet Proper.

B: 6) Treasury funded—enables liquidity present for urgent needs.

C: 7) My Own Personal FMV Tax Amortization Deduction Facility (IRS 2005);

Major Inventive Step: Utilize My FMV to give U.S. per capita citizens/taxpayers real raise.

D: 7a)b) Net-Equal Swap: Net Tangible to Me Required—No Gift.

E: 7a)b) FMV is Mine, solely, personally, individually; FMV.

F: 8) Front-End License.

G: 9) Back-End FMV and Uses of Net-Equal Swap.

H: 10) Treasury Assets Retire Debt, Re-Fi On-the-Run.

I: 11) My Royalty, in O/CPLT, substantial, further Aids U.S.A.

I: 12) After My Death, my Portfolio can be Managed by Expert Team.

FIG. 3A: Applicable Licensee Industries.

FIG. 3B: DEMAND-SIDE STIMULUS VIA BACK-END STRUCTURE.

FIGS. 4A through 4D: “My Defacto Patents/Applications by Dec. 22, 2009 O/CPLT”; I previously sent in Dec. 8, 2010 Application, Filing “Additional Supplemental Matter”.

These sent by me to USPTO Jan. 27, 2011: Not New Matter: If Viewed as “New Matter”, Remove and Keep as Exhibit.

FIG. 5A: CONSUMPTION FUNCTION, Broad Atomistic Per Capita Demand-Side Stimulus utilizing my FMV Savings.

FIG. 5B: GOVERNMENT: ENACTS, MAINTAINS, REQUIRES.

FIG. 5C: FREE LUNCH ACHIEVED: C+I+G: My Savings, My IAs.

My Drawings, FIG. 4A through FIG. 4D, document in affidavit by my solemn signature and attestation, also on record in the original filing documents, the great or vast throve of my pro-se Independent Inventor and Author in Entirety, I, myself, the sole inventor, sole applicant, sole author and sole owner, of my myriad Patents, Applications (Provisionals, Non-Provisionals, PCTs Internationals, Divisionals, Abandoneds, Priority, Parent, Child, Unfileds, concurrently, my 30+ Library of Congress Copyright Office Copyright Registrations (all of which—every Registration and its Deposit—I am the sole Author, sole registrant, and sole Owner of All Matter in Algorithms, First Publications, Graphics, Music, Musical Composition, Performance and Recording, Computer Software and coded Programs and Spreadsheets), the whole of which, excluding none, I have never transferred, sold, assigned, lent, mortgaged, borrowed against, held as collateral for business or stock, have always been and remain, like my IRS FMV tax deduction facility, in my own personal hands, for I am an individual. This also includes my spoken word, image and name. I reserve all right to my biography.

In addition to my written Specification and my Drawings, my Patent Application filing (by USPS Express Mail) of Dec. 8, 2010, contained my appendix “Additional Supplemental Matter” of thirty-four (34) sheets, comprising my personal private proprietary Trade Secret Energy Intellectual Property, rocketry designs, letters and text messages bundles to USPTO and Official U.S. Institutions—U.S. Departments of State and of Treasury/IRS, and U.S. Library of Congress Copyright Office—on my “O/CPLT”. A few are enclosed herein, as Figures, supplying reference.

FIG. 6A, 6B, two sheets, “My Will and Testament . . . ”, type Living Will, dated and signed by me (in California, my residence State, 7/2002 to present) Dec. 2, 2009, initiating U.S.A. as my Heir, and Executor, O/CPLT-manager of my Intangible Assets, in my absence or in the event of my Death. No rejection received.

FIG. 7A, 7B, two sheets, “Our (USA and I) Counter-Party License Transaction”, “O/CPLT”, of Apr. 20, 2010: sketching Treasury Asset creation from Intangible Assets; a brief of my (unpaid to date) twenty-four years as pro-se Independent Inventor, my Works, commencing with my 1985 Multi-National Composite Currency (now, called the Euro); and my IRS FMV tax deduction (non-transferable, -assignable, -inheritable). Sheet One concludes with my Attestation, I am sole owner, sole inventor, sole author. Sheet Two, viable Treasury Asset constructions, corresponding to Patent and Copyright protection longevity and bond types.

FIGS. 8A, 8B, 8C are copy of a letter I wrote to the Director of the USPTO, a letter enthusiastic in the opportunities for my Intangible Assets, docketed Treasury Assets benefiting the U.S.A. (eg. as Bond instruments), to avail funding for U.S.A. to address National, State and Regional welfare, bail-out and technological advancements. I did not receive any express response from USPTO.

FIG. 9A Outlines formal and mechanical Structure of O/CPLT, specific Tender of my own IAs and IRS-approved FMV tax deduction, with Terms of Tender/Mandates on Proceeds detailed in my Mar. 6, 2011 1:45 am pac text message, said message soft confirmed U.S. Treasury.

FIGS. 10A through 10G highlight and summarize various aspects and inventive steps presented and described herein, U.S. patent Ser. No. 12/928,357, including, Asset-side Balance sheet entry, ledger of my IAs to U.S. Treasury/FRB Book, U.S. Federal Distribution of Use-License to U.S. Industry Companies via Its relevant Regulatory Agency and/or Industry Council.

FIG. 11, if O/CPLT is transacted, shows its final specifics and details, completed and executed O/CPLT, between U.S.A. Federal Executive and myself, US/US pro-se Independent Inventor/Author/Owner, with the USPTO, Library of Congress, and the IRS as witnesses [ed. not as yet occurred, Nov. 15, 2011]. In my hand-scripted pen-and-ink Tenbder, dated and signed by me, Jun. 1, 2011, I repeat Tender Offer per FIG. 9A.

1. A method, wherein Intangible Assets are provided improved status on a Balance Sheet of Assets and Liabilities, comprising re-booking an Intangible Asset from the Liability side, and placing its netted present discounted value, if positive, on the Asset-Side of the Balance Sheet.

2. A Treasury Asset, a financial term instrument paying or receiving periodic payments, whether actual or by phantom accretion, of interest and royalty, comprising:
a financial term instrument bearing a Face Value amount, said Face Value is approximate the Revenue Scope of the underlying or packaged Intangible Asset, a promise of interest or royalty payments made or received, and conveying and licensing use and commercialization, and sub-license, Rights of said underlying Intangible Asset, said Rights expressly delineated in the written deed of said Treasury Asset, to the Party to which said Treasury Asset is issued, said Treasury Asset term complying with lifetime of protected Rights and Entitlements enveloping said underlying Intangible Asset, said enveloped Rights and Entitlements conveyed in said Treasury Asset instrument.

3. A method by which an inventor's cost of inventing and patenting and protecting intellectual and copyright Rights and Entitlements on own invention, or collection of inventions, comprising protected Intangible Asset, which further comprises,
a Fair Market calculation of the Value, or discounted present value of said invention's aggregate Revenue Scope in Economy, of said protected Intangible Asset respective lifetime royalty earnings, summing industry-applicable royalty rate, determining present discounted value of the lifetime royalty aggregate, dividing by fifteen, yielding the fifteen-year straight-line amortization deduction, per annum, for each of fifteen years, availing inventor as tax deduction on royalty received each said given year of fifteen.

4. A Demand-Side Stimulus to the general Economy, comprising:
a net-equal value swap of an inventor's IRS Fair Market Value tax amortization deduction, said deduction availed against royalty received, said swap to a National, municipal or civic governmental body, said body having tax levy, bond issuance capability and a mass of resident taxpayers, said body swapping appropriate net-equal cash or tangible value equivalent to said inventor, appropriate comprising mathematical measure of tax dollar savings with respect to the National or municipal franchise of said body, yielding swap rate between the two said parties to said swap, wherein inventor's FMV tax deduction broadly or majority useful and valuable to said governmental body, wherein said body distributing said tax deduction aggregate received per said swap rate to taxpayer residents of said body, providing said taxpayer residents a per capita, or other formulated division, portion of said aggregate received via said swap, functioning as atomistic stimulus of the Economy from the Demand, consumer taxpayer, or supplier company, side.
